(19) United States
(12) Patent Application Publication
(10) Pub. No.: US 2010/0139498 A1
(43) Pub. Date: Jun. 10, 2010

(54) Cooking Pot for both Steaming and Boiling

(76) Inventor: Ching-Horng CHANG, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/199,140

(22) Filed: Aug. 27, 2008

(30) Foreign Application Priority Data
Aug. 27, 2007 (TW) 096214254

(51) Int. Cl. A47J 27/04

(52) U.S. Cl. 99/410

(57) ABSTRACT

This invention discloses a cooking pot for both steaming and boiling, which including a deep pot body forming a first holding space therein, a chimney container which has an end thereof disposed in the first holding space of pot body and another end thereof having a opening and a second holding space therein, and a steam container which is placed on the opening of the chimney container and facing the second holding space. Once the pot body is heated, water in the second holding space of the chimney container boils and produces steam air to cook food in the steam container.

### RELATED APPLICATIONS

This application claims priority to Taiwan Application Serial Number 96214254, filed Aug. 27, 2007, which is herein incorporated by reference.

### BACKGROUND

1. Field of Invention

This invention is related to a pot, and more particularly to a cooking pot for both steaming and boiling.

2. Description of Related Art

Chinese cuisine is diversified and profound There are many ways to prepare Chinese food including boiling, steaming, roasting, stewing, heating, frying, sautéing and braising. However, no matter how complicated Chinese cuisine is to prepare, a set of convenient and useful cookers is needed to effectively prepare the cuisine. In view of this, people in the related industries are dedicated to producing a novel and effective set of cookers to make good looking and tasty food, thus, cooks in restaurants can satisfy the demanded of customers and then get a good reputation while using such set of cooker.

For instance, in a hot pot restaurant, the popular ways of hot pot cooking now are “Hot Pot BBQ” and “Yin Yang Pot.” The “Hot Pot BBQ” has a hot pot area and a BBQ grill area so that users can both boil and BBQ their food. The “Yin Yang Pot” is a partitioned pot that enables different foods with different flavors to be prepared in the same pot.

However, in addition to the forgoing hot pot cooking, customers expect other ways of hot pot cooking for curiosity and for the joy of cooking by themselves. Therefore, the restaurant owner may lead another modern fashion hot pot cooking markets when a novel pot is invented again.

### SUMMARY

It is therefore an objective of the present invention to present a cooking pot for both steaming and boiling to provide an option other than “Hot Pot BBQ” and “Yin Yang Pot”.

To achieve the foregoing objectives, the present invention provides a cooking pot for both steaming and boiling, comprising a pot body, a chimney container and at least one steam container, wherein the pot body has a deep first holding space therein, the chimney container has an end thereof disposed in the first holding space, an opposite end thereof has an opening, and a second holding space in the chimney container connecting to the opening; and the steam container is placed on the opening of the chimney container and faces the second holding space. Once the pot body gets heat, water in the second holding space of the chimney container boils and produces steam flowing towards the steam container to cook food in the steam container.

In a preferred embodiment of the present invention, the chimney container is set on the inner central surface of the pot body in the first holding space. If the amount of the steam container is more than one, the steam containers could be piled with each other on the opening.

According to another embodiment of the invention, a supporter is covered over the opening of the chimney container and facing the second holding space to avoid falling into the second holding space. The supporter has a plurality of holes equidistantly penetrated thereon. Each of the holes is capable of holding one of the steam containers. Therefore, if there are more than one steam containers, the steam containers can also be horizontally placed on the opening of the chimney container.

In addition to the above embodiments, a heat conductive layer is electrically conductive and is disposed on an outer surface of the pot body opposite to the chimney container. Since the heat conductive layer is made by electrically conductive metal, the pot body can be placed on an apparatus that converts electricity into heat (e.g. electric magnetic cooker) by the heat conductive layer to achieve even heat-conduction.

To sum up, the present invention introduces a new way of hot pot cooking to provide both steaming and boiling to fresh the customers who expect a new mode of hot pot cooking.

### BRIEF DESCRIPTION OF THE DRAWINGS

The structure and the technical means adopted by the present invention to achieve the above and other objects can be best understood by referring to the following detailed description of the preferred embodiments and the accompanying drawings, where:

FIG. 1 is an exploded view of a cooking pot for both steaming and boiling according to a preferred embodiment of the present invention;

FIG. 2 is a top view of the cooking pot with partitions according to the embodiment of the present invention;

FIG. 3 is an exploded view of a cooking pot for both steaming and boiling according to another embodiment of the present invention.

### DESCRIPTION OF THE PREFERRED EMBODIMENTS

It is to be understood that the following disclosure provides one or more preferred embodiment, or examples, for implementing different features of the disclosure. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

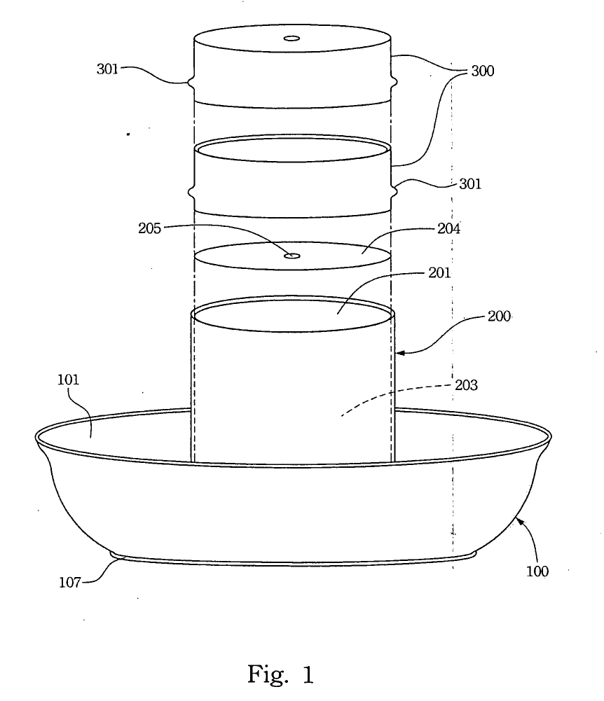

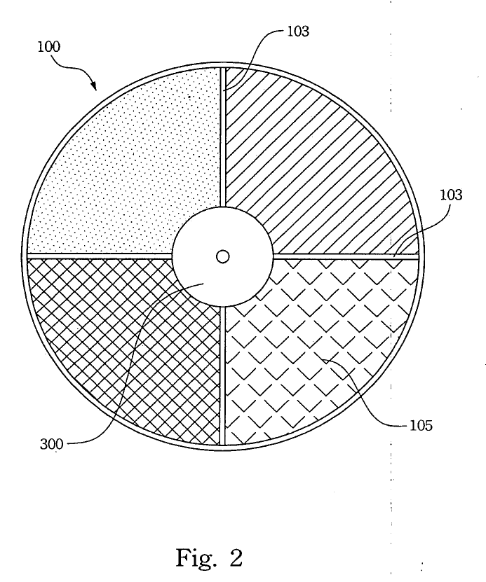

Refer to FIG. 1 and FIG. 2. FIG. 1 is an exploded view of a cooking pot for both steaming and boiling according to a preferred embodiment of the present invention, and FIG. 2 is a top view of the cooking pot with partitions according to the embodiment of the present invention. The present invention “cooking pot for both steaming and boiling” in the preferred embodiment comprises a pot body 100, a chimney container 200 and at least a steam container 300 (e.g. a wooden or bamboo steamer). The pot body 100 has a first holding space 101 in an inner surface of one side thereof. The first holding space 101 is used to contain hot pot soup, ingredients and food material. Also, some partition boards 103 are set in the first holding space 101 and coupled to the chimney container 200 to separately form room 105 between every two partition boards 103. Therefore, each room 105 can be filled with different flavors of soup, such as spicy hot soup or curry soup.

In the preferred embodiment, the chimney container 200 is set on the inner central surface of the pot body 100 in the first holding space 101 and has an end thereof coupling to the inner central surface of the pot body 100, an opposite end thereof with an opening 201, and a second holding space 203 in the chimney container 200 which connects to the opening 201. The second holding space 203 either is provided to fill dips (e.g. cheese and chocolate sauces) or soups (e.g. spicy hot soup or curry soup) for customers to cook a meat/food string (e.g. BBQ chicken string or Mongolian boiled lamb) by dipping into the dips or soups. The second holding space 203 can also be filled with water rather than dips or soups to steam the steam container 300 placed over the opening 201. Once the pot body 100 is heated, water in the second holding space 203 of the chimney container 200 boils and produces steam. The steam flows towards the steam container 300 and cooks any food (e.g. eggs or seafood) inside the steam container 300.

The chimney container 300 in above embodiment can only hold one steam container 300 over the opening 201, in which the steam container 300 has a peripheral flange 301 on the outer surface thereof. The steam container 300 can be fixed on the chimney container 200 by its peripheral flange 301, so that the steam container 300 is prevented from falling into the second holding space 203. If more than one steam container 300 is used, the steam containers 300 can be piled on top of each other over the opening 201. However, the top of the steam container 300 may fail to receive any steam and food contained therein will not be cooked or heated. Therefore, in order to ensure the top of the steam container 300 can be provided with enough heat from the stream flows, a top lid 204 with at least one air vent 205 covers the opening 201. High-pressure steam flows can spurt from the air vent 205 to the top of the steam container 300 and provide enough heat, while the water in the second holding space 203 is boiling.

Since the chimney container 200 in the above embodiment can only hold a few steam containers 300 that are piled on top of each other, the steam containers 300 can only be piled up to a limited height to ensure safety, and customers have to wait for steaming another steam containers 300 until some over the chimney container 200 are done. Therefore, it is time-consuming and may dissatisfy customers.

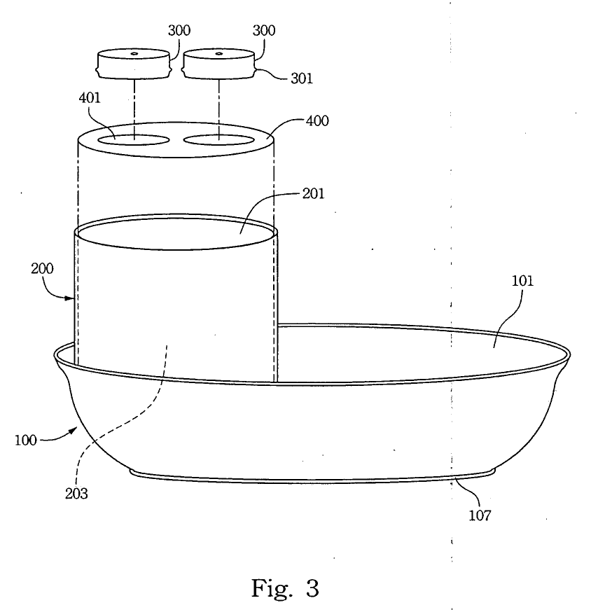

Refer to FIG. 3. FIG. 3 is an exploded view of a cooking pot for both steaming and boiling according to another embodiment of the present invention. According to another embodiment of the invention, a supporter 400 is covered over the opening 201 of the chimney container 200, and faces the second holding space 201. The supporter 400 has some holes 401 equidistantly spaced thereon. Each of the holes 401 is capable of receiving and holding one of the steam containers 300, and gaining concentrated steam flows. Therefore, more steam container 300 can be placed horizontally on the chimney container 200 and reduce the waiting time before steam containers 300 on the chimney container 200 are done.

Additionally, a heat-conductive layer 107, made by electrically conductive metal (e.g. stainless steel, chromium and iron), is disposed on an outer surface of the pot body 100 opposite to the chimney container 200. When the pot body 100 is placed on an apparatus that converts electricity into heat (e.g. electric magnetic cooker) by the heat-conductive layer 107, the pot body 100, the heat-conductive layer 107 will provide a uniform distribution of heat to the pot body 100. Next, water placed in the second holding space 203 of the chimney container 200 is heated, and boils. The steam from the boiling water from the second holding space 203 flows towards the steam container 300 and cooks the food therein.

In conclusion, the embodiments of the present invention “cooking pot for both steaming and boiling” are novel and inventive. Customers should be freshened by the present invention in a new way of hot pot cooking. Therefore, the present invention is qualified to be granted the patent right.

Although the present invention has been described in considerable detail with reference in the certain preferred embodiments thereof, other embodiments may place the chimney container 200 near the edge of inner surface of the pot body 100 rather than to limit the chimney container only on the inner central surface of the pot body 100. Therefore, the spirit and scope of the appended claims should not be limited to the description of the preferred embodiments contained herein.

It will be apparent to those skilled in the art that various modifications and variations can be made to the structure of the present invention without parting from the scope or spirit of the invention. In view of the foregoing, it is intended that the present invention cover modifications and variations of this invention provided they fall within the scope of the following claims and their equivalents.

1. A cooking pot for both steaming and boiling, comprising:
a pot body having a first holding space therein;
a chimney container having an end of the chimney container disposed in the first holding space, an opposite end of the chimney container having an opening, and a second holding space in the chimney container connecting to the opening; and
at least one steam container placed on the opening of, the chimney container and facing the second holding space.

2. The cooking pot for both steaming and boiling as claimed in claim 1, wherein the chimney container is set on the inner central surface of the pot body in the first holding space.

3. The cooking pot for both steaming and boiling as claimed in claim 1, wherein the chimney container is set near the edge of the pot body in the first holding space.

4. The cooking pot for both steaming and boiling as claimed in claim 2, wherein two or more steam containers are piled up with each other on the opening.

5. The cooking pot for both steaming and boiling as claimed in claim 4, wherein a top lid having at least an air vent, is covered on the opening.

6. The cooking pot for both steaming and boiling as claimed in claim 4, wherein a supporter is covered on the opening of the chimney container, and having at least a hole penetrated thereon for receiving and holding the steam container.

7. The cooking pot for both steaming and boiling as claimed in claim 3, wherein more than two steam containers are piled with each other on the opening.

8. The cooking pot for both steaming and boiling as claimed in claim 7, wherein a top lid having at least an air vent, is covered on the opening.

9. The cooking pot for both steaming and boiling as claimed in claim 7, wherein a supporter is covered on the opening of the chimney container, and having at least a hole penetrated thereon for holding the steam container.

10. The cooking pot for both steaming and boiling as claimed in claim 2, wherein a plurality of partition boards is set in the inner surface of the pot body in the first holding space and a room is formed between every two partition boards.

11. The cooking pot for both steaming and boiling as claimed in claim 3, wherein a plurality of partition boards is set in the inner surface of the pot body in the first holding space and a room is formed between every two partition boards.

12. The cooking pot for both steaming and boiling as claimed in claim 5, wherein the steam container is a steamer made by wood or bamboo.

13. The cooking pot for both steaming and boiling as claimed in claim 1, wherein a heat conductive layer, which is electrically conductive, is disposed on an outer surface of the pot body opposite to the chimney container.
